(19) United States
(12) Patent Application Publication
(10) Pub. No.: US 2009/0322563 A1
(43) Pub. Date: Dec. 31, 2009

(54) Autonomous provisional smart traffic signal station

(76) Inventors: Malcolm Leroy Stadtmiller, Sunnyvale, CA (US); Jennifer Alice Bullard, Sunnyvale, CA (US)

Correspondence Address: Walt Froloff, 273D Searidge Rd, Aptos, CA, 95003, US

(21) Appl. No.: 12/217,211

(22) Filed: Jun. 30, 2008

(51) Int. Cl. G08G 1/07

(52) U.S. Cl. 340/909

(57) ABSTRACT

The present invention discloses a mode selectable autonomous provisional traffic signal station unit for establishing traffic control signal light units for mode selectable alternate traffic control configurations. The autonomous provisional traffic signal station further comprises a mode switch to engage unit logic to receive wireless broadcast protocol seeking a slave unit or broadcast protocol as a master unit seeking a slave unit, and programming logic for co-operating traffic control of a road segment managing un-manned two direction vehicle traffic over a temporarily converged alternating one direction flow. An un-manned traffic grid mode is also disclosed

### BACKGROUND

### Field of the Invention

The present invention relates generally to traffic signals and specifically to temporary site traffic signal lights and autonomous signal lights co-operating to route traffic though lane closed sites funneling two directional traffic through a one lane segment.

### Current Traffic Signals

Traffic is perhaps the largest bane of modern man's existence. As the number of vehicles increases, population densities continue to increase, roads, streets and highways become more used and more contested. These bring a host of problems. More construction, power failures and disabled control intersections operating sub-optimally, civil emergencies man made and natural. When these events transpire, trained individuals are dispatched, to serve a very rudimentary function wasting manpower while slowing traffic further, exacerbating the problem further.

Various partial solutions exist. A personal warning light comprising a plurality of light emitting diode light sources connected and arranged to display small highly efficient light emitting diode light sources as single signal lights has been suggested. While more energy efficient, this does not address most other larger traffic problems.

Portable signal lights for guiding vehicle traffic have also been proposed. These function as hand tools for individual directing traffic. While these are a more efficient tool than manual traffic control, it falls short of a totally unmanned solution. Moreover, there are many possible traffic situations and circumstances and scenarios which a traffic light to which a traffic light must adapt, and these do not adequately address many situations which require a portable provisional traffic signal light.

There is the typical construction, one lane two way construction or repair site traffic, the general one intersection traffic control for broken systems or temporary traffic control at concerts, community events, accidents. Then there is a need from civil emergencies caused by human error, terrorism or natural disasters. Some traffic solutions require a system of light units to manage a grid accommodating traffic. What is needed are units that have selectable modes of operation so that one unit or one type of unit can be dispatched to a traffic location without regard to the situation or circumstance to be accommodated.

Automated traffic control system that emulate the actions and decisions of flagmen to control and to expedite traffic along a two lane turned single lane have also been disclosed. These typically have two portable traffic signal light stations with arms to simulate the flagmen or workers. The mechanical arms, multiple video cameras on both stations, and two way radio communication are used, increasing the complexity, awkwardness, maintenance, power drain and generally all costs. These systems must have remote control for starting and stopping the system along with a manual overrides.

Other features are generally added which add to cost, and not necessarily for the improvement of traffic control.

These autonomous flag-signal multiple cameras and are very expensive systems. Also, the cost of mechanical arm emulation escalates the cost. Moreover, a simple algorithm for motion detection by a fixed camera compares the current image with a reference image and simply counts the number of different pixels. Since images will naturally differ due to factors such as varying lighting, camera flicker and CCD dark currents, pre-processing is useful to reduce the number of false positives. More complex algorithms are necessary to detect motion when the camera itself is moving, or when the motion of a specific object must be detected in a field containing other movement which can be ignored, as in the case of a line of vehicles or traffic. Furthermore, wireless technologies are limited, and in hilly or remote regions, the master must still engage the slave unit. Thus, camera operated signal light systems offered have many challenges.

However, there are other sensors and cost reductions which can be made. Motion detectors come in passive infrared (PIR), ultrasonic, active, sensor sends out pulses and measures the reflection off a moving object, microwave, active, sensor sends out microwave pulses and measures the reflection off a moving object similar to a police radar gun. Then there are dual-technology motion detectors which use a combination of different technologies. These dual-technology detectors benefit with each type of sensor, and false alarms are reduced. Most marketed sensors have the option to use PIR/Microwave Motion Detectors that have “Pet-Immune” functions which allow the detector to ignore pets that weigh up to 40 pounds (wireless models) or 80 pounds (hard-wired models). Often, PIR technology will be paired with another model to maximize accuracy and reduce energy usage. PIR draws less energy than microwave detection, and so many sensors are calibrated so that when the PIR sensor is tripped, it activated a microwave sensor. If the later also picks up an signal, then the event is confirmed.

At times, loss of power takes out the signal lights on an entire grid. The signal lights available are not help there, they are islands of control unto themselves. What is needed are intelligent control signals, that co-operate and co-ordinate to resolve a larger traffic problem.

What is needed are adjustable, distance extendable, power sustainable, self operating autonomous traffic control systems and structures, which can function when such adverse transient situations arise and in remote areas where wireless technology has limitations. These systems must be autonomous, mobile, readily available at a moments notice and reliable, without undue complexity, without large processing needs, network connectivity or large expensive technology. Costs must be as low as possible, as these may be needed in large quantities for ready quick application.

### SUMMARY

The present invention discloses a mode selectable autonomous provisional traffic signal station unit with a housing comprising at least four lights disposed in four opposing directions, at least four signal lights in each of the disposed opposing directions, at least one motion diction sensor for detecting motion in each of the disposed directions, a power source providing power to traffic unit components, at least one antenna for wireless communication with at least one other co-operating signal light unit or central station, a reset switch capable of cycling power to unit, a mode selector control interface, a computing device with memory and I/O for processing embedded electronic logic with GPS, and electronic logic for controlling at least one signal light unit,

whereby vehicular traffic for a variety of situations can be controlled through at least one traffic signal light unit mode selectable for alternate traffic control configurations.

The autonomous provisional traffic signal station further comprises a mode switch to engage unit logic to receive wireless broadcast protocol seeking a slave unit or broadcast protocol as a master unit seeking a slave unit, and programming logic for co-operating traffic control of a road segment managing two direction vehicle traffic over a temporarily converged alternating one direction flow. A traffic grid mode is also disclosed

### BRIEF DESCRIPTION OF DRAWINGS

FIG. 1 is a perspective view of an autonomous provisional traffic signal station, in accordance with an embodiment of the invention.

FIG. 2 is a cross-section view of an autonomous provisional traffic signal station, in accordance with an embodiment of the invention.

FIG. 3 illustrates a traffic station locking leg of an autonomous provisional traffic signal station, in accordance with an embodiment of the invention.

FIG. 4 is a top view of an autonomous provisional traffic signal station, in accordance with an embodiment of the invention.

FIG. 5 is the situational single station traffic control signal diagram, in accordance with an embodiment of the invention.

FIG. 6 is a high level block diagram of an autonomous traffic control station internals, in accordance with an embodiment of the invention.

FIG. 7 is the layout diagram for two-way traffic control over a single lane segment traffic control using a Master-Slave 2 station configuration, in accordance with an embodiment of the invention.

FIG. 8. shows a high level logic flow diagram of an autonomous traffic control signal station with typical green, yellow and red lights, in accordance with an embodiment of the invention.

FIG. 9. shows a high level logic flow diagram of an autonomous traffic control signal station with typical green, yellow, red, and left tern signal lights, in accordance with an embodiment of the invention.

FIG. 10. is a two station master-slave mode logic flow diagram of a co-operating master-slave set traffic control signal light master mode, in accordance with an embodiment of the invention.

FIG. 11. is a two station master-slave mode logic flow diagram of a co-operating two station set traffic control signal light master mode continuation, in accordance with an embodiment of the invention.

FIG. 12. is a two station master-slave mode logic flow diagram of a co-operating two station set traffic control signal light slave mode, in accordance with an embodiment of the invention.

FIG. 13. is map layout illustrating Grid mode, in accordance with an embodiment of the invention.

FIG. 14. is a high level logic flow diagram for a co-operating n station traffic control signal light system in Grid mode, in accordance with an embodiment of the invention.

### DETAILED DESCRIPTION

Specific embodiments of the invention will now be described in detail with reference to the accompanying figures.

In the following detailed description of embodiments of the invention, specific details are set forth in order to provide a more thorough understanding of the invention. However, it will be apparent to one of ordinary skill in the art that the invention may be practiced without these specific details in lieu of substitutes. In other instances, features have not been described in detail to avoid unnecessarily duplication and complication.

### Objects and Advantages

The present invention provides an apparatus for quickly establishing autonomous vehicle traffic control, for intersections where signal lights are non-functioning, where signal lights are temporarily needed, or at road segments where work in progress reduces simultaneous two way to time shared single lane two way traffic.

An object of the invention is traffic control through stations co-operating through wireless communication channels, which establish a consistent coherency to unmanned traffic control, acting as a traffic control system capable of expansion to needed distance or length.

Another object of the invention is to make the signal light stations simple to use and relatively inexpensive, so that they can be stored in mobile units and used as necessary.

Another objective of the invention is simplicity of installation and use.

Another objective of the invention is to maintain power source units standardized to the available off the self power supplies

Another objective is to use leds for light sources to minimize power consumption.

Another objective is uniform simple LED display for simple integration and fabrication to reduce costs and simplify installation and use.

Another objective of the invention is a simple user interface for programmable modes and functions.

Another objective of the invention is to use conventional off the self electronic components and standards for low costs.

Another objective of the invention is the use of inexpensive proximity sensors adequate for the function needed, for counting vehicles at relatively low speeds. Another object of the invention is the use of GPS and wireless communication standards to provide on demand interrupts for problems and malfunctions.

Another object of the invention is to extend power source life through the use of solar photovoltaic arrays, complete with rechargeable power sources.

Another object of the invention is to provide a simple and/or remote wireless reset function.

### Figure Details and Discussion

Proximity and motion sensors are able to detect the presence of nearby objects without physical contact. A motion sensor often emits an electromagnetic or electrostatic field, or a beam of electromagnetic radiation (infrared, for instance), and looks for changes in the field or return signal. The object being sensed is often referred to as the proximity sensor's target. Different proximity sensor targets demand different sensors. For example, a capacitive or photoelectric sensor might be suitable for a plastic target; an inductive proximity sensor requires a metal target.

The maximum distance that this sensor can detect is defined “nominal range”. Some sensors have adjustments of the nominal range or means to report a graduated detection distance. Embodiments of the invention will automate these settings to accommodate the traffic and road dimensions specifically.

Proximity sensors can have a high reliability and long functional life because of the absence of mechanical parts and lack of physical contact between sensor and the sensed object. Aspects of the invention will exploit these characteristics for reliability and low power consumption.

Some embodiments of the invention will have sensors with digital output, the output is essentially an approximation of the measured property. The approximation error is also digitization error and dynamic or sampling frequency error, or temperature affects errors. These deviations can be handled in software and compensated for in known strategies for these sensors.

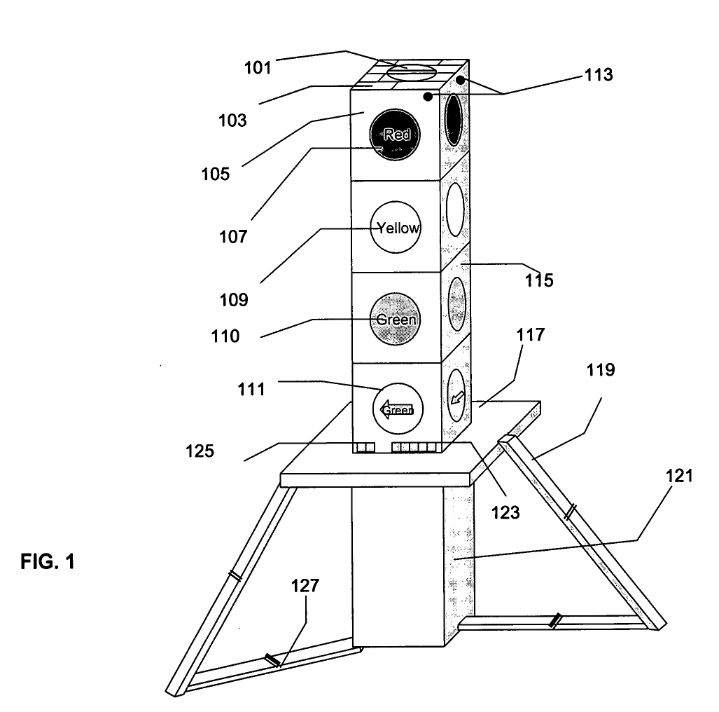

FIG. 1 is a perspective view of an autonomous provisional traffic signal station, in accordance with an embodiment of the invention. The elements shown include a foldable carry handle 101, a token solar cell 103 which represents a much larger area, panels 105 comprising four signal lamps, red 107, yellow 109, green 110, and left turn arrow 111, motion detection sensors 113, housing 115, base board 117, legs 119, base outer housing 121, mode indicators 123, power and reset 125 indicators, and hinged leg locks 127. The signal lamps 107 109 110 111 can be conventional, LED or any other feasible technology. The station unit is installable and portable for quickness and convenience on its foldable legs 119 and lockable hinges 127, putting the station unit in a very stable position, accommodating for the existing level or terrain.

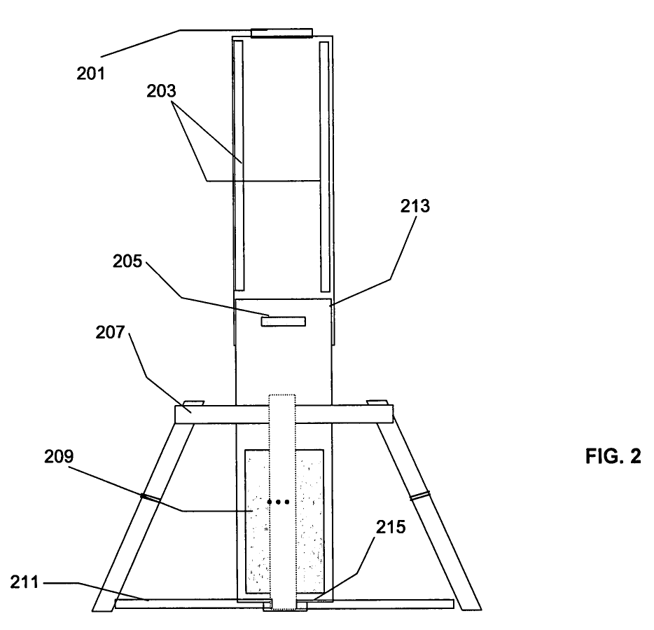

FIG. 2 is a cross-section view of an autonomous provisional traffic signal station, in accordance with an embodiment of the invention. Shown are the handle 201 for porting and delivering to off site locations, light arrays 203 for the signal lights which could be LED banks or other technology, the power—reset—mode indicators 205 which provide visual information as to amount of power available, reset status and mode of operation desired, base 207 to support upper end of the legs 211, interior housing incasing power source and electronics 209, overlap housing 213 to support LED panels and allow watershed flow from weather and bottom weight 215 for stability.

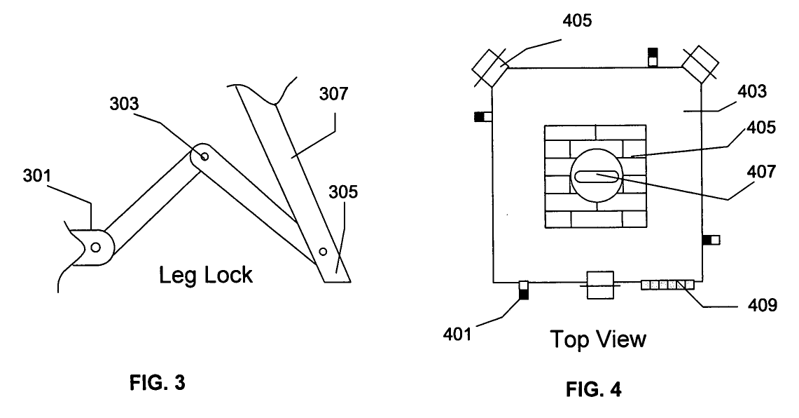

FIG. 3 illustrates a traffic station locking leg of an autonomous provisional traffic signal station, in accordance with an embodiment of the invention. One leg link is anchored 301 to the station base bottom, and has a hinge lock link 303 to another leg segment rotatably linked 305 at the ground contact side, foot, of a leg segment linked 307 to the station base plate. This configuration leg design provides a stable station unit platform while conveniently foldable for transport and storage.

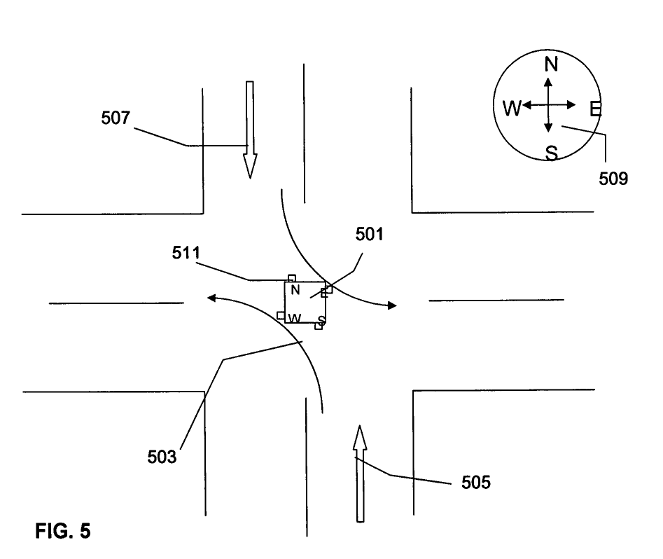

FIG. 4 is a top view of an autonomous provisional traffic signal station, in accordance with an embodiment of the invention. As in other embodiments, a carry handle 407 is coupled to top of unit, where a relatively small but representative solar cell array 405 is situated, on the outer housing 403. The station is supported vertically on foldable legs with footers 405. Sensors 401 are located on each panel direction, and power-reset-mode indicators 409 are positioned on one panel side.

FIG. 5 is the situational single station traffic control signal diagram, in accordance with an embodiment of the invention. The traffic control station 501 for the single station modes is typically positioned in the middle of an intersection in need of traffic management. The single station mode will have a left turn signal mode and also a non-left signal mode where appropriate. In an artificial compass 509 baring, traffic will typically traverse in the North 505 and South 507 directions with an intermittent left turn 503 to be equitably allowed. This is likewise in the East and West traffic flows. The traffic station 501 will have at least one motion detector sensor 511 in each or the four directions. This is not to indicate that each sensor detects and registers the traffic for just that one direction. Each sensor can server multiple purposes. The most obvious is traffic approaching will register motion in the face direction. However, that same traffic will register on the perpendicular face sensor as it passes, and the station logic will use that aspect of the invention to keep track of number of mobile units crossing the intersection, and also for other embodiments of the invention in alternate traffic configurations, as in the master-slave mode.

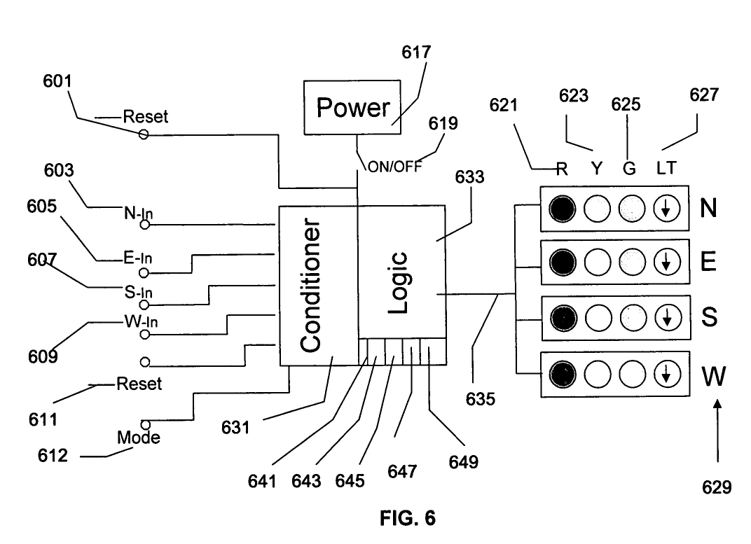

FIG. 6 is a high level block diagram of an autonomous traffic control station internals, in accordance with an embodiment of the invention. A source of power 617 flows upon demand switch 619 to logic circuitry 633, conditioner circuitry 631, sensors 603 605 607 609 and reset logic 611 diagnostics and signal lamp circuits 635 to power on/off lamps 621 623 625 627. The logic circuitry can include wire communication logic, GPS logic, smart antenna logic, USB and standard I/O bus and supporting logic and custom reprogrammable logic where new circumstances require slight changes in logic to retain intelligence. Not shown in the schematic, the power switch 619 can be remotely initiated or manually. A softer, logic reset 611, is also provided where power is not a problem and a quicker, remote controlled system re-initialization is required. The N, E, S, W detector sensors, 603 605 607 and 609 respectively, in some embodiments, will serve multiple purposes, in detection and validation of traffic. Sensor signals 603 605 607 and 609 may require conditioning 631 for compatibility with digital logic 633, which will have several modes having an input indicator selectable from the outside Mode 612 input indicator. The sensors 603 605 607 and 609, power 617 and mode 612 provide the inputs to the logic 633, which then operates the lights 621 623 625 627 in the appropriate directions 629. The lights will be in banks, per the typical color red 621 yellow 623 green 625 and left turn (LT) 627 sets for the different directions 629. Logic can be programmed to initiate interrupt calls by sensor signals SIG(x), where x is one of N 603, E 605, S 607, W 609 directions. The signal lights can be controlled by routine calls to initiate light circuits on or off with programmed time sequences, SEQ (R, Y, G), For example SEQ (R, Y, G) can represent a command to turn each light, red, yellow and then green, in sequence, each for a particular time period, and command sent from the program logic 633 through the I/O represented by line 635 connecting to the physical light arrays 621 623 625 627 for each direction 629. Standard off the shelf circuitry to provide wireless connectivity 641, receiver 643, transmitter 645, GPS 647, and other 649 circuits are used to provide the functionality for the several modes of operation.

Motion detector sensors 603 605 607 and 609 can be passive infrared (PIR), ultrasonic, active sensor pulse and measure, microwave pulse and measure, dual-technology motion detectors which use a combination of different technologies and others.

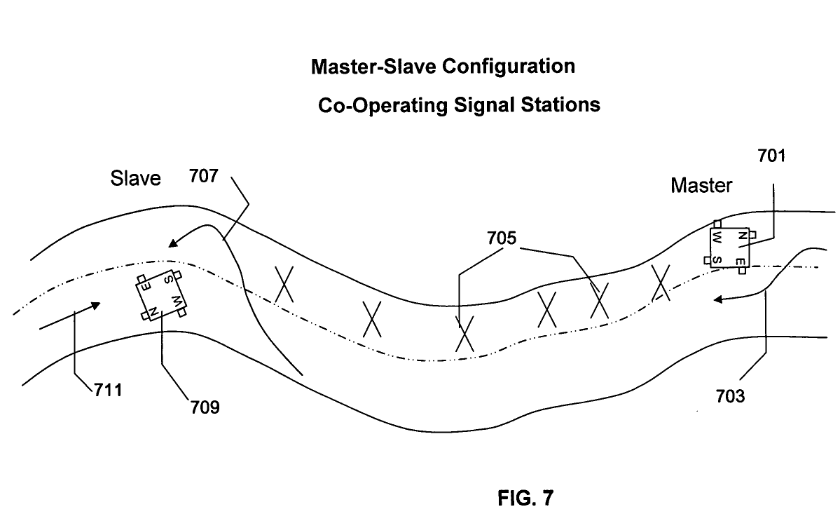

FIG. 7 is the layout diagram for two-way traffic control over a single lane segment traffic control using a Master-Slave 2 station configuration, in accordance with an embodiment of the invention. This configuration occurs during construction, repair, accidents, road debris, fallen trees, landslides and many other temporary situations which will warrant repair crews and traffic control personnel. This is a wasteful application for traffic personnel where the traffic can be managed by intelligent devices. The problem zone traffic reconfiguration typically requires two signal stations 701 709 on opposite ends of the control segment. A master station 701 allows the blocked lane 703 access to the opposite traffic lane for alternate periods routing this traffic around the obstruction 705 lane to the opposite end of the control segment where the traffic is then routed to its home lane 707 once again by the slave station 709, which keeps the opposing traffic 711 waiting its turn to proceed in the opposite direction when the only lane is clear once again.

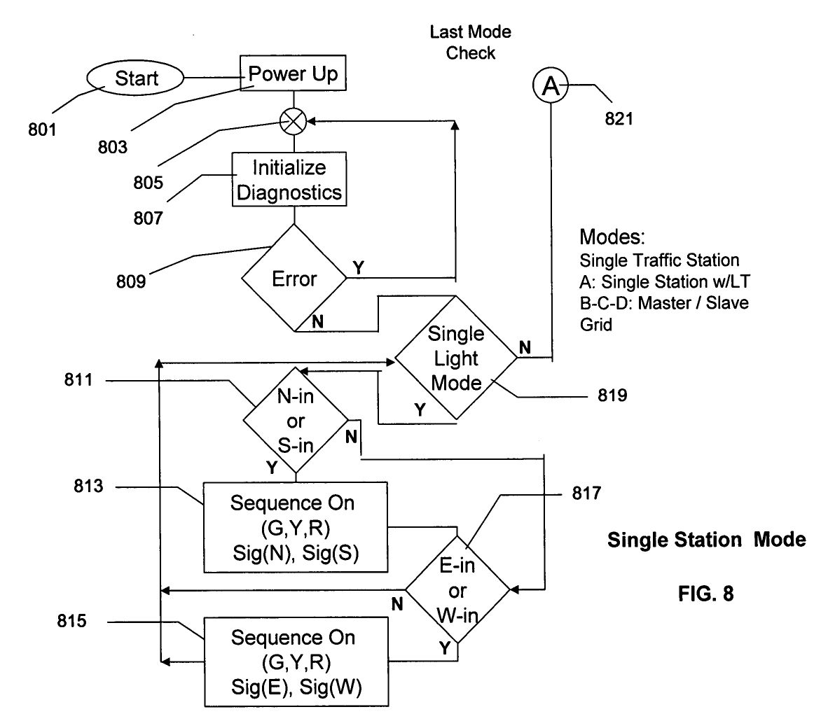

FIG. 8. shows a high level logic flow diagram of an autonomous traffic control single station with typical green, yellow and red light sequences, in accordance with an embodiment of the invention.

At start 801, power 803 is initiated either manually or remotely, and the logic will thread to a set of logic hardware 805 which will undergo initialization and diagnostics 807 checking. Any sensor approximation error, digitization error, dynamic or sampling frequency error, temperature affects errors, calibration errors 809, which cannot be self adjusted or compensated will be done to an acceptable level. Many deviations can be handled in software and compensated for in known strategies for these sensors. Results outside acceptable levels will branch logic to a redundant set of hardware login 805. Healthy diagnostics results will thread logic to check which single station mode was selected 819. If the three light only mode is selected, logic branches to reading sensors 811 N-in and S-in for detected motion. Detected motion in these signals indicates presence of traffic in those directions and hence the system will respond with command sequence, SequenceOn(G, Y, R), to turn on the Green light, Yellow light and then Red lights in a timed sequence, for the North, Sig(N), and South, Sig(S) panels. A negative response to the Single Station Mode 819 will thread execution to the alternate Single Station Mode with additional left turn (LT) lights 821 designated terminal A.

If no signals from the N-S sensor traffic 811 are detected, then no traffic in the N-S direction need be passed, and the N and S light panels will receive a red signal, Sig(R), and the execution will thread to check for East and West traffic sensor signals. Any E or W sensor signals 817 will trigger the command sequence, SequenceOn(G, Y, R) 815, to turn on the Green light, Yellow light and then Red lights in a timed sequence, for the East, Sig(E), and West, Sig(W) panels. A negative response to the E-W sensor signals 817 will thread execution back to the Single Station Mode 819 check.

Execution logic from the N-S sequence 813 will thread to the “East” and “West” sensors for any signals of traffic there 817, and the command sequence, SequenceOn(G, Y, R), to turn on the Green light, Yellow light and then Red lights in a timed sequence, East, Sig(E), and West, Sig(W) light panels in the affirmative signal, traffic found. This will loop back to the Single Station Mode 819 until a mode signal is sensed to power is terminated.

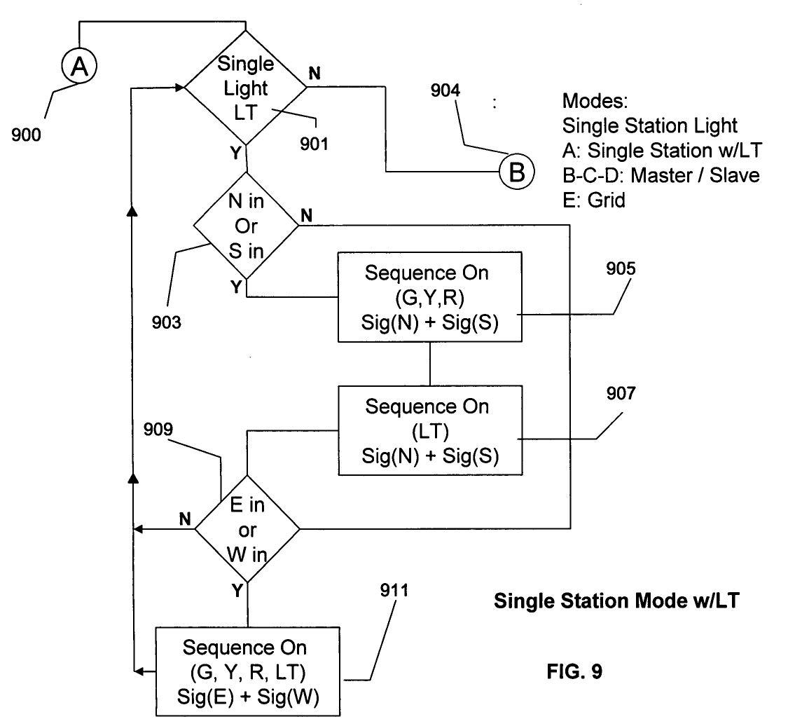

FIG. 9. shows a high level logic flow diagram of an autonomous traffic control single station mode with typical green, yellow, red, and left tern signal lights, in accordance with an embodiment of the invention.

If the mode selected is Single Station with Left Turn 901 signal, then the execution will branch to read North and South sensors 903 for signals. In the negative, the logic will continue on to find another mode 904 of operation. A positive signal from N or S sensors 903 will thread command to execute the sequence for lighting green, yellow and then red, SequenceOn(G, Y, R) 905 on the N and S, Sig(N) +Sig(S), light panels. This will be followed by the left turn, SequenceOn(LT) 907 command to the N and S, Sig(N) and Sig(S), light panels to turn on the left turn arrow light.

If the N and S reads 903 produce no sensor signals, no traffic in the North or South directions to control, or the N-S light sequence 907 completes, the thread of execution will branch to E and W sensor reads 909. Traffic detected signals, will thread execution to sequence the green, yellow, red and then the left turn, Sequence On (G, Y, R, LT) to the E and W light panels 911, Sig(E) and Sig(W). If no E or W traffic is detected 909, then execution will thread back to Single Station LT mode check 901, to continue the loop until cessation of power or a alternate mode 904 is selected.

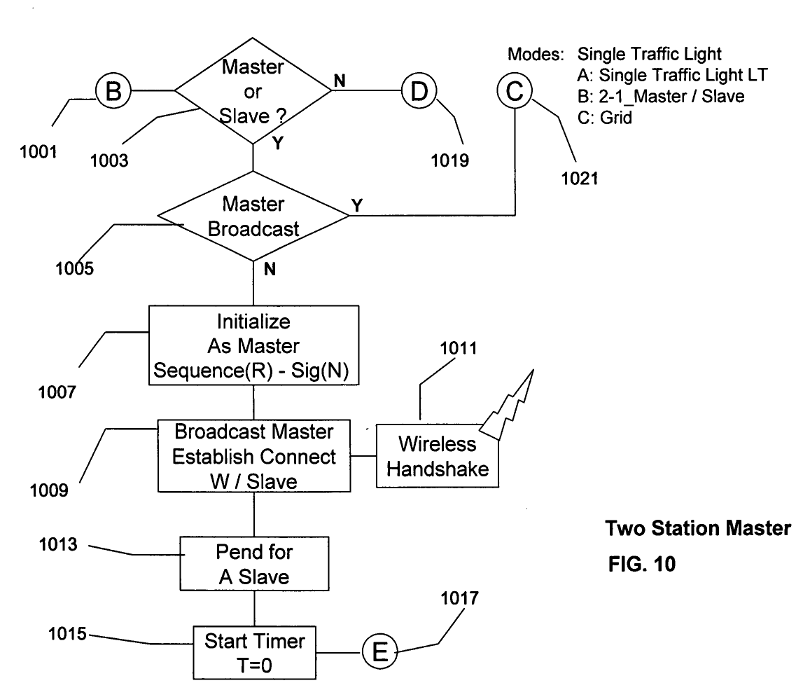

FIG. 10. is a two station master-slave mode logic flow diagram of a co-operating master-slave set traffic control signal light master mode, in accordance with an embodiment of the invention. The logic thread starts at “B” 1001, if triggered by a mode selection for a Master-Slave master role 1003, the execution proceeds to broadcast as master role 1005. A negative response to a master-slave switch 1003 will branch execution to “D” 1019, for contention with another broadcasting master role. An affirmative response will initiate a broadcast 1005 in search of any already allocated slave traffic stations. Absent an immediate response from another master, “D” 1019, the master will then broadcast seeking response from a slave, “C” 1021. Execution will continue to Initialize this station as master 1007, which will after a diagnostics check sequence the red light, Sequence(R), on the North signal panel, Sig(N), to halt any traffic until acknowledgement from a co-operating slave unit signifies that it is safe to allow passage through the bottle neck one lane segment. The master station will then broadcast 1009 as search protocol for a slave through a wireless handshake 1011, and pend on a count down timer awaiting response from a slave 1013. A wireless handshake 1011 from the slave will start a timer 1015 indicating that a co-operating slave station has initialized and given the stop signal to opposing traffic to keep segment clear from opposing traffic.

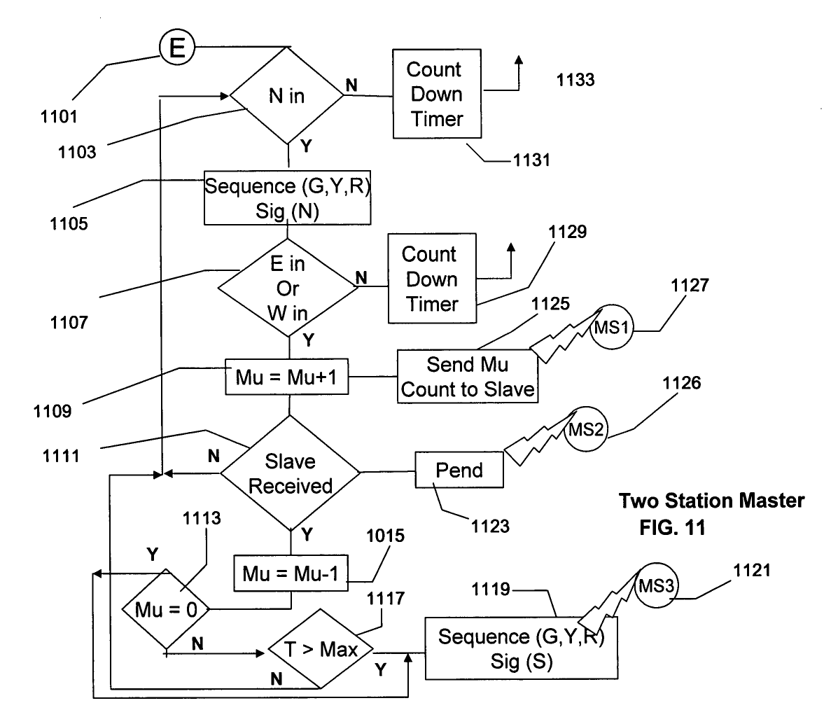

FIG. 11. is a two station master-slave mode logic continuation flow diagram of a co-operating two station set traffic control signal light master mode continuation, in accordance with an embodiment of the invention. The logic continues from FIG. 10 “E” 1101 to check that there is still south bound traffic waiting 1103. In the negative, the master will pend on a count down timer 1131 which will return execution 1133 to logic to check the slave for traffic awaiting. An affirmative response 1103 will give the North light panel the command to sequence through a green, yellow and red, Sequence(G, Y, R) signal to the North panel, Sig(N) 1105. As the south bound traffic (symbolically represented only) passes the E or W sensors will register and signals 1107 to a counter 1109 accumulating the number of mobile units, Mu, which enter the segment. This number is sent to the slave message MS1 1125 by wireless communication, for verification of passing through the segment. E or W sensors 1107 not registering passing traffic will initiate a count down timer 1129 which branches execution to error logic, sensor recalibration or adjustment, possible rollover to redundant logic and user notification of such in the event of a hardware error. Execution will pend a process 1123 awaiting reception or confirmation MS2 1126 and will, without further notice from slave on mobile unit 1111, Mu, status, continue to branch to N sensor 1103 looking for more incoming traffic. A slave signaling 1126 Mu status 1111 will allow logic to decrement mobile unit count Mu 1015 and to check that the controlled road segment is clear 1113 of all traffic. If mobile units remain in the segment 1113 execution branches back to the N sensor signal read 1103 for indication of more traffic. If the there is more mobile units in the segment, execution branches to check for total max time 1117 and any remaining time will allow traffic to continue 1103. Exceeding the Max set time, the sequence of green, yellow and red light duration time, will broadcast to the slave to allow 1119 to allow traffic into the segment. No mobile units 1113 will likewise branch execution to notify the slave 1119 that the flow can switch, MS3 1121.

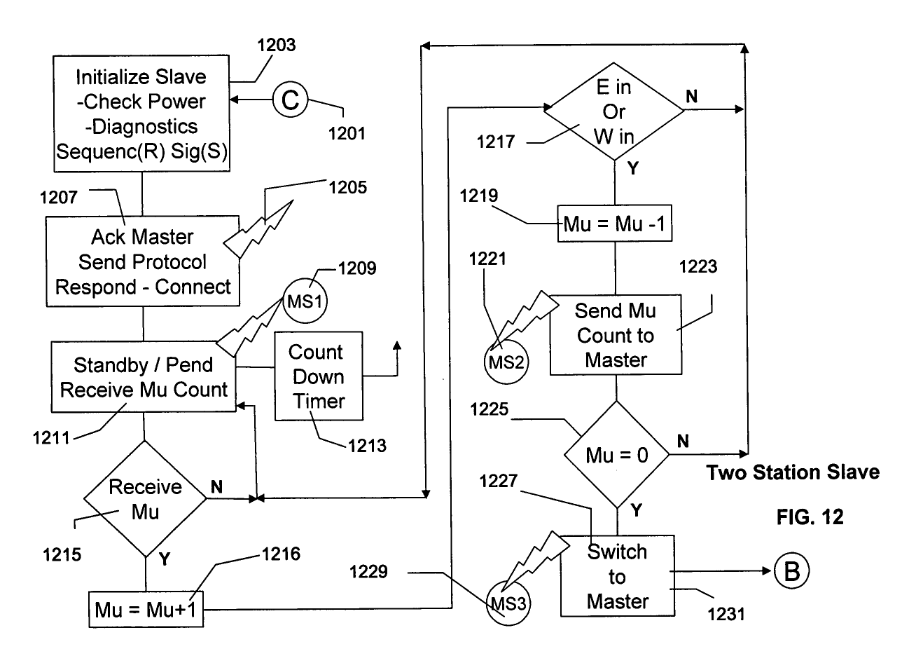

FIG. 12. is a two station master-slave mode logic flow diagram of a co-operating two station set traffic control signal light station in slave mode, in accordance with an embodiment of the invention. A station with selected slave mode 1201 will initialize as a slave, check for adequate power, perform hardware and software diagnostics and upon successful initialization, issue a sequence of red light, Sequence(R), to the South panel, Sig(S) 1203. The slave station will then broadcast 1205 acknowledging the master station and requesting connection protocol 1207. Execution will then prepare buffers and pend awaiting mobile unit count as the road segment traffic begins 1211, exchanging the Mu data and protocol for reception, and start a count down timer 1213 to return execution if nothing concludes. Upon receiving mobile unit counts 1215, the mobile unit count Mu will increment 1216 the Mu accumulator and await mobile unit signals on it E or W sensors 1217. Negative signals will send execution back to awaits master send Mu data. Afirmative sensor reads will indicate mobile units leaving the controlled road segment and the Mu accumulator will decrement 1219 and send new mobile unit count to master 1223, via its wireless protocol message MS2. When the mobile unit count 1225 goes to zero, the slave unit will signal this to the master unit 1231 aboard the wireless communication message protocol MS3 1229. Execution will then branch to “B” where the master unit determines if the south bound timer has reached its maximum set duration and when the opposing traffic, if any, should be allowed through the controlled road segment.

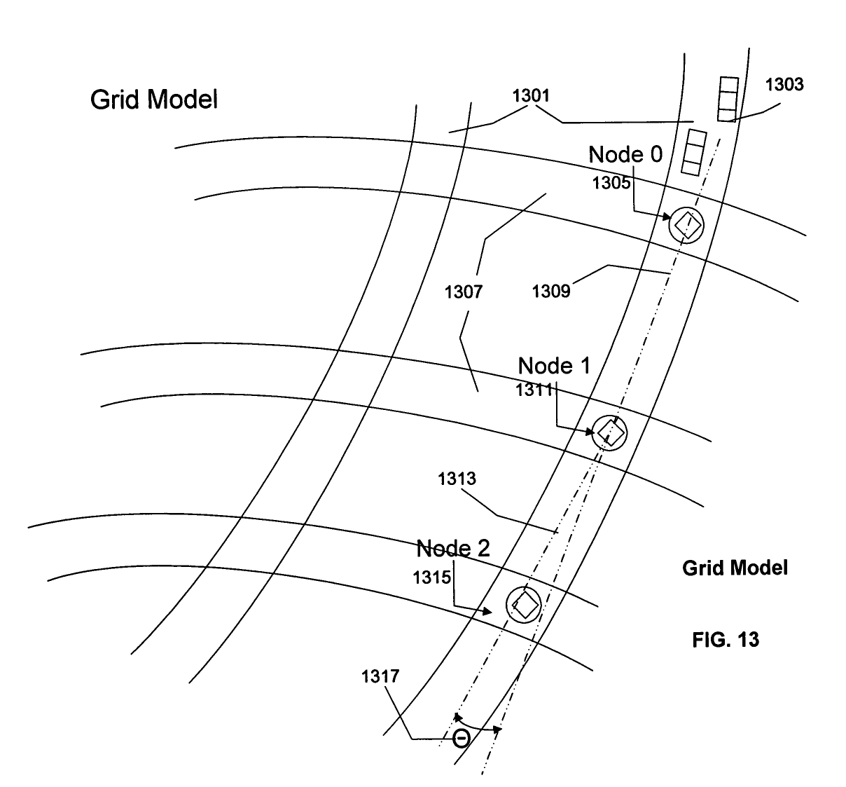

FIG. 13. is map layout illustrating Grid mode, in accordance with an embodiment of the invention. Grid mode is used in emergencies that damage infrastructure and nullify traffic control systems in a traffic grid, street cross hatch or vehicle flow network. A second traffic control station, node 1 1311 with node 0 1305 will define a link or segment and a straight line between them will define a flow direction for the signal light. GPS can be used to establish geographic positions for the flow axis 1309. Few traffic grids are straight line cross hatches, and so the next node, node 2 1315, with the preceding node 1 1311, will define another link or segment contiguous to the same flow direction as in the previous link 1309. The map flow direction between link 2 1313 and link 1 1309 may have an offset angle to the original flow direction, link 1 1309. This offset angle theta 1317 will be compared with a 90 degree difference to continue to define as flow direction or cross-traffic cross flow 1307. The flow and cross flow links or segment GPS directions can vary and the logic will continue to co-ordinate stations to promote a smooth moving traffic flow to maximize grid traffic throughput with timed starts and stops at the traffic intersection points.

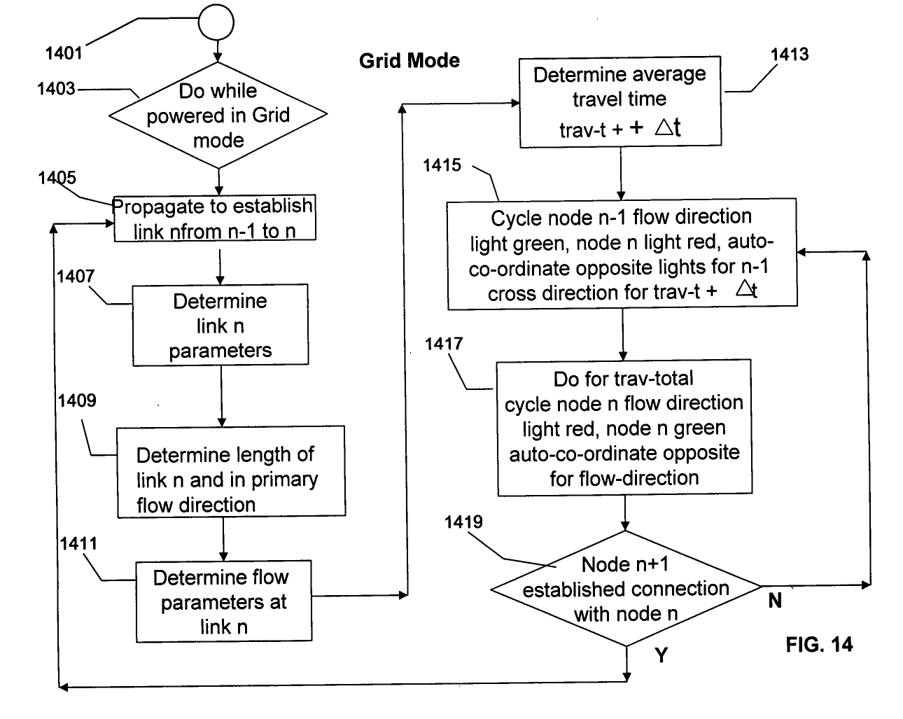

FIG. 14. is a high level logic flow diagram for a co-operating n station traffic control signal light system in Grid mode, in accordance with an embodiment of the invention. The station powered up 1401 and mode selection in Grid Mode 1403 starts logic to identify the link or segment 1405 between two stations. Starting with the Node 0, root station, the next nearest station by GPS determined positions will be the configured as Node 1. The distance between stations will be modeled as a straight line, which may vary slightly with curved segments from the actual distance. The adjacency from one node to the next will count the links of a chain or network of hops 1407. A signal station will establish communication through a simple protocol, exchanging status and establishing node position in the flow chain to root station. This signal will upon establishment, propagate to subsequent nodes along chain. Adjacency removed from the number of nodes to the root node will represent the number of hops total. Each additional hop has an individual segment or link travel time, trav-t 1409 between the nodes which will to be calculated to account for the different GPS distance and avg rate of traffic speed between nodes of each additional hop. In FIG. 13 the hop 1 link 1309 between Node 0 1305 and Node 1 1311 will have a travel time trav-t of segment distance as calculated from GPS positions divided by a selectable or sensor measured average rate of traffic speed for the link. Likewise, any given node n station parameters signal light cycle times will be calculated based on the distance between the previous adjacent station or node n−1 and the current node n divided by the average rate of speed. An additional time increment may be added to the trav-t 1409 if the trav-t 1409 is shorter than a permissible setting, causing a disproportionate unfairness to the cross-flow direction 1411 where there should not be. The travel time for the segment and any addition selected time will constitute the total open traffic cycle called Green, to include Green, Yellow and/or left turn light metering the flow direction. Likewise, the time parameter will coincide with the red light cycle for the cross flow 1413, equal to the total travel time defined for the flow direction traffic for that same node.

A previous node, n−1, will then cycle on a green signal light, red for cross-flow traffic, based on its trav-total for its link n−1 and n−2 1415. Concurrently, the node n, will be in red. Upon n−1 cycling to red, node n will cycle green based on its link travel time, concurrently cycling red for its cross flow traffic accordingly in the reverse cycle red. The current node n can also receive signal to and from another node, n+1 1419, for which it will spawn another process upon successful established protocol 1405 with another node to propagate a further link immediately continguous. Its parent process will continue to execute the traffic cycle for its original link 1415.

Signal light stations established in the cross flow directions will behave similarly, only the cross flow direction becomes their flow direction, and the algorithm propagates from link to link, each keeping its hop count from the root. This is only a simple fundamental cycle of grid configured traffic flow implementation and many more sophisticated network traffic algorithms and implementations are available to those skilled in the art.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A mode selectable autonomous provisional traffic signal station unit comprising:
a housing comprising at least four lights disposed in four opposing directions;
at least four signal lights in each of the disposed opposing directions;
at least one motion detection sensor for detecting motion in each of the disposed directions;
a power source providing power to traffic unit components;
at least one antenna for wireless communication with at least one other co-operating signal light unit or central station;
a reset switch capable of cycling power to unit;
a mode selector control interface;
a computing device with memory and I/O for processing embedded electronic storage media with electronic logic circuits;
electronic logic for controlling at least one signal light unit,
whereby vehicular traffic for a variety of situations can be controlled through at least one traffic signal light unit mode selectable for alternate traffic control configurations.

2. An autonomous provisional traffic signal station unit as in claim 1 further comprising a mode switch to engage unit logic to receive wireless broadcast protocol seeking a slave unit or broadcast protocol as a master unit seeking a slave unit, and programming logic for co-operating traffic control of a road segment managing two direction vehicle traffic over a temporarily converged alternating one direction flow.

3. An autonomous provisional traffic signal station unit as in claim 1 further comprising motion sensors from a group of motion sensors consisting of passive infrared (PIR), ultrasonic, active, microwave and dual-technology motion.

4. An autonomous provisional traffic signal station unit as in claim 1 further comprising a antenna with GPS for ascertaining station geographic coordinates.

5. An autonomous provisional traffic signal station unit as in claim 4 further comprising logic for group of traffic configurations consisting essentially of single traffic intersection, a master-slave, and a grid traffic mode.

6. An autonomous provisional traffic signal station unit as in claim 1 further comprising a reset by remote wireless device.

7. An autonomous provisional traffic signal station unit as in claim 1 further comprising a solar array to extend power source life.

8. An autonomous provisional traffic signal station unit as in claim 1 further comprising a telescoping extendable housing

9. An autonomous provisional traffic signal station unit as in claim 1 further comprising a unit housing carry handle.

10. An autonomous provisional traffic signal station unit as in claim 1 further comprising a extendable base legs.

11. An autonomous provisional traffic signal station unit as in claim 1 further comprising a LED light arrays for signal lights.

12. An autonomous provisional traffic signal station unit as in claim 1 further comprising communication protocol logic for establishing communication with a acknowledging available cooperating signal station at a road segment converting 2 way traffic into alternating one way traffic pulses.

13. An autonomous provisional traffic signal station unit as in claim 12 further comprising communication protocol logic sending the count of vehicles passing its location and accepting the number of vehicles exiting the acknowledging signal station position.

14. An autonomous provisional traffic signal station unit as in claim 1 further comprising executable logic for calibration of sensors, diagnostics for hardware components and output devices.

15. An autonomous provisional traffic signal station unit as in claim 1 further comprising a GPS component providing communication stations to configure grid traffic flows automatically, by propagation of node parameters, calculation of distances between nodes by GPS position, establishing and communication of traffic average rate of flow by input parameter defaults or measurement, and coordinating green and red cycle times by triggering n node signal station flow open upon reaching a travel time calculated for link segment distance calculated between n−1 and n node.
